(19) United States
(12) Patent Application Publication
(10) Pub. No.: US 2024/0296012 A1
(43) Pub. Date: Sep. 5, 2024

(54) MULTIPLY-ACCUMULATE CIRCUIT AND METHOD FOR PERFORMING MULTIPLY-ACCUMULATE OPERATIONS

(71) Applicant: Robert Bosch GmbH, Stuttgart (DE)

(72) Inventors: Andre Guntoro, Weil Der Stadt (DE); Michael Beyer, Stuttgart (DE)

(21) Appl. No.: 18/588,205

(22) Filed: Feb. 27, 2024

(30) Foreign Application Priority Data
Mar. 1, 2023 (DE) 10 2023 201 851.9
Feb. 8, 2024 (DE) 10 2024 201 148.7

(51) Int. Cl. G06F 7/544; G06F 7/50; G06F 7/53

(52) U.S. Cl. CPC G06F 7/5443; G06F 7/50; G06F 7/5306

(57) ABSTRACT

A multiply-accumulate circuit for processing numerical values that are present as input words, each of which is formed from at least two partial words. The circuit is configured, corresponding to a permutation selected from a plurality of permutation possibilities implemented by the multiply-accumulate circuit, to form product partial words as products of in each case one partial word of the first input word with one partial word of the second input word, wherein in the products, the partial words of the first input word are permutated relative to their original order corresponding to the selected permutation; and to add the product partial words with an accumulation word, which is formed from one or more partial words, to determine an updated accumulation word in which product partial words are in each case added to one of the one or more partial words of the accumulation word.

### CROSS REFERENCE

The present application claims the benefit under 35 U.S.C. § 119 of German Patent Application Nos. DE 10 2023 201 851.9 filed on Mar. 1, 2023 and DE 10 2024 201 148.7 filed on Feb. 8, 2024, which are expressly incorporated herein by reference in their entireties.

### FIELD

The present invention relates to a multiply-accumulate circuit and to a method for performing multiply-accumulate operations.

### BACKGROUND INFORMATION

Artificial neural networks, such as so-called convolutional neural networks (CNN), can have a deep and complex topology which necessitates considerable computational effort and energy consumption. In order to reduce these effects, dedicated hardware accelerators or optimized algorithms can, for example, be used.

### SUMMARY

According to the present invention, a multiply-accumulate circuit and a method for performing multiply-accumulate operations are provided. Advantageous example embodiment of the present invention are disclosed herein.

According to the present invention, the multiply-accumulate circuit is configured or constructed in such a way that product partial words are formed from partial words of a first and a second input word, wherein the partial words of the first input word are selectably permutated in accordance with one of a plurality of permutation possibilities. The product partial words are added to an accumulation word that comprises one or more partial words. Accordingly, the first input word can be used several times, in each case with a different permutation. Memory accesses costly in time and energy can thus be reduced so that the efficiency of performing multiply-accumulate operations can be increased.

In detail, according to an example embodiment of the present invention, a multiply-accumulate circuit is provided for processing in particular scalar numerical values that are present as input words, each of which is formed from at least two partial words, which circuit is configured, optionally corresponding to a permutation selection given by a permutation signal, to form product partial words as products of in each case one partial word of the first input word with one partial word of the second input word from a plurality of permutation possibilities implemented by the multiply-accumulate circuit, wherein in the products the partial words of the first input word are permutated relative to their original order corresponding to the selected permutation possibility; and to add the product partial words with an accumulation word, which is formed from one or more partial words, in order to determine an updated accumulation word in which product partial words are in each case added to one of the one or more partial words of the accumulation word.

Permutation is understood in the sense that, in addition to a swapping of the partial words, a non-swapping of the partial words is also regarded as a permutation possibility. For example, in the case of the first input word consisting of two partial words: (a₁, a₀), two permutation possibilities: (a₁, a₀), i.e., no swapping, and (a₀, a₁), i.e., swapping. In the case of more than two partial words, there are correspondingly more permutation possibilities; for example, in the case of three partial words, there are six permutation possibilities. In the case of more than two (potentially possible) permutation possibilities, not all of them need to be implemented in the multiply-accumulate circuit. According to one embodiment, however, all potentially possible permutation possibilities can be implemented in the multiply-accumulate circuit. The first and the second partial word can, but need not, have the same number of partial words.

The wording that the multiply-accumulate circuit is “configured” to perform a particular step or to implement a particular functionality is to be understood such that the multiply-accumulate circuit is configured for this in hardware terms. The multiply-accumulate circuit thus comprises corresponding hardware functional elements which implement the relevant step or the relevant functionality, wherein the execution takes place in using control signals (e.g., clock signals) or in response to control signals. If different steps or functionalities are carried out “optionally,” this means that the multiply-accumulate circuit can be controlled or configured with a corresponding control signal (permutation signal, multiplication signal, accumulation signal), so that one of the corresponding different steps or functionalities is selected and then executed. For this purpose, the multiply-accumulate circuit has for example different hardware paths, which are in each case selected.

In one example embodiment of the present invention, the multiply-accumulate circuit is configured to add each of the product partial words to a corresponding one of the partial words of the accumulation word, wherein the number of partial words of the accumulation word is equal to the number of product partial words. Accordingly, there is a 1-to-1 relationship between product partial words and partial words of the accumulation word. For example, if the first and the second input word are given as (a₁, a₀) and (b₁, b₀) and also the accumulation word as (acc₁, acc₀), and swapping is selected as a permutation possibility for the partial words of the first input word, this results in acc_{1,neu}=acc_{1,alt}+a₀·b₁; acc_{0,neu}=acc_{0,alt}+a₁·b₀ for the new or updated partial words of the accumulation word. In addition, corresponding to the notation frequently used in informatics, the subscripts “old,” “new” are omitted.

In one example embodiment of the present invention, the multiply-accumulate circuit is configured, optionally corresponding to an accumulation signal, to add each of the product partial words to a corresponding one of the partial words of the accumulation word, wherein the number of partial words of the accumulation word is equal to the number of product partial words, or to add a plurality of the product partial words to the same partial word of the accumulation word, wherein the accumulation word is formed in particular from only one partial word. According to this embodiment, a selection or accumulation selection of a plurality of different ways of adding the product partial words to the accumulation word is provided, wherein this accumulation selection is made by means of the accumulation signal, i.e., the multiply-accumulate circuit is controlled or configured with the accumulation signal, so that it performs the type of accumulation corresponding to the accumulation selection. In addition to the already mentioned accumulation type, in which there is a 1-to-1 relationship between product partial words and partial words of the accumulation word, and in which corresponding product partial words and partial words of the accumulation word are added together, it can additionally be selected as an accumulation type that a plurality of the product partial words are added to the same partial word of the accumulation word. This second selection possibility can generally in turn comprise a plurality of (in each case implemented in hardware) sub-types of accumulation, i.e., a plurality of sub-types, regarding how the product partial words are added to which partial words of the accumulation word. In particular, the accumulation word can consist of only one partial word, so that all product partial words are added thereto, e.g., in the case of two partial words of the input words as above, if swapping is again selected as a permutation possibility: acc=acc+a₀·b₁+a₁·b₀, wherein acc denotes a partial word of the accumulation word.

In a further embodiment, the multiply-accumulate circuit is configured, optionally corresponding to the accumulation signal, to add the product partial words with at least partially different weight factors to the corresponding partial word of the accumulation word. Likewise, in a further embodiment, the multiply-accumulate circuit can be configured, optionally corresponding to the accumulation signal, to add a plurality of the product partial words to the same partial word of the accumulation word, wherein the product partial words which are added to the same partial word of the accumulation word are added with at least partially different weight factors, wherein the accumulation word is formed in particular from only one partial word. In these further embodiments, product partial words are multiplied by the weight factors and then added to the corresponding partial word of the accumulation word. In particular, powers of 2 are provided as weight factors, since in the case of binary values these can be easily realized by a corresponding shift of the bits or, in the case of floating point numbers, by changing the exponent. In particular, if the accumulation word has only one partial word, a whole number multiplication of the first and the second input word can also be realized. For example, if in the case of binary input words for which each partial word has n/2 bits, the first and the second input word are again given as (a₁, d₀) and (b₁, b₀) and the accumulation word with only one partial word given as acc, the multiply-accumulate circuit can first be controlled without swapping the partial words of the first input word, so that with a corresponding weight factor starting from an accumulation word initialized with zero acc=2ⁿ·a₁·b₁+a₀·b₀ results and then is controlled with swapping so that acc=acc+2^{n/2}·a₁·b₁+2^{n/2}·a₁·b₀ or overall acc=2ⁿ·a₁·b₁+2^{n/2}·a₀·b₁+2^{n/2}·a₁·b₀+a₀·b₀ results. Here a₁ and b₁ represent the partial words that correspond to the higher-value bits, and a₀ and b₀ represent the partial words that correspond to the lower-value bits.

In one example embodiment of the present invention, the multiply-accumulate circuit is configured to determine in parallel the product partial words for at least two of the plurality of implemented permutation possibilities, and from these product partial words to select in accordance with the permutation signal the product partial words which correspond to one or more of the permutation possibilities and to use them in the addition with the accumulation word. According to this embodiment, all product partial words for at least two of the plurality of implemented permutation possibilities are first determined in parallel, i.e., the multiply-accumulate circuit has corresponding parallel paths. In particular, the multiply-accumulate circuit can be configured such that the product partial words are determined in parallel for all permutation possibilities implemented in the circuit. The selection (in accordance with the permutation signal) is then made of the product partial words to be used, which are to be added with the accumulation word, i.e., with its partial words. In this case, the product partial words of a single permutation possibility can be selected, or the product partial words of a plurality, in particular of all, of the permutation possibilities can be selected. This selection is made in each case in accordance with the permutation signal, for example the multiply-accumulate circuit is configured accordingly in response to the permutation signal. If the product partial words of all permutation possibilities are determined in parallel and if the multiply-accumulate circuit implements all possible permutation possibilities, it will be possible, for example, to optionally carry out a multiplication of the first and the second input word together with the use of weight factors, if these input words are taken as a whole as numerical values.

A method according to the present invention is applied using a multiply-accumulate circuit according to the present invention and comprises reading a first word to be processed and a second word to be processed from a memory; controlling the multiply-accumulate circuit to perform a first multiply-accumulate operation, wherein the first word to be processed is used as the first input word, the second word to be processed is used as the second input word, and a first permutation selection is made from the at least two permutation possibilities; reading a third processing word from the memory; controlling the multiply-accumulate circuit to perform a second multiply-accumulate operation, wherein the first word to be processed is used as a first input word, the third word to be processed is used as the second input word, and a second permutation selection, which is different from the first permutation selection, is made from the at least two permutation possibilities; and reading out the accumulation word or partial words of the accumulation word.

Further advantages and embodiments of the present invention can be found in the description and the figures.

The present invention is shown schematically in the figures on the basis of exemplary embodiments and is described below with reference to the figures.

### BRIEF DESCRIPTION OF THE DRAWINGS

FIG. 1 shows a multiply-accumulate circuit according to an exemplary embodiment of the present invention.

FIGS. 2A, 2B, 2C, 2D illustrate a convolution operation as an example of an operation that can be performed using the multiply-accumulate circuit shown in FIG. 1.

FIG. 3 shows an exemplary flowchart of the method for performing multiply-accumulate operations.

### DETAILED DESCRIPTION OF EXAMPLE EMBODIMENTS

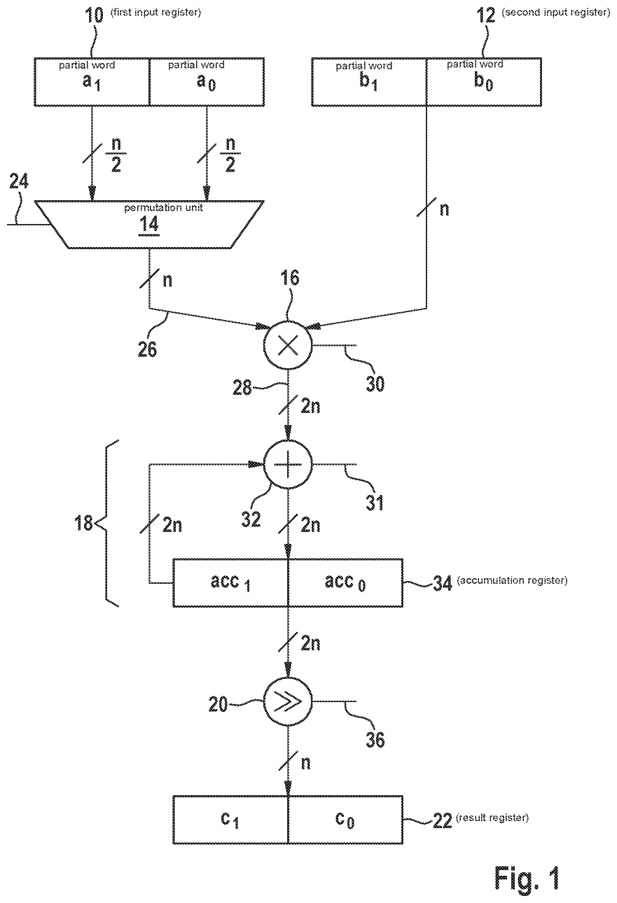

FIG. 1 shows a multiply-accumulate circuit or arithmetic unit for multiply-accumulate operations according to an exemplary embodiment of the present invention.

The multiply-accumulate circuit shown (also referred to in simplified form as a MAC circuit or MAC unit) comprises a first input register 10, a second input register 12, a permutation unit 14, a multiplication unit 16, an accumulation unit 18, a bit shift unit 20, and a result register 22.

The MAC circuit is used to process numerical values that are present as digital values (e.g., binary values) referred to as words or bit words. The words to be processed (referred to as input words) have a specific (first) bit number or length, which is, for example, equal to n. Each word includes two partial words (a₁, a₀ or b₁, b₀), i.e., is formed by two partial words. The partial words each have a specific bit number or length, which is equal to n/2, for example. The input words (if they are in each case regarded as a whole as numerical values) or their partial words (if these are in each case regarded as independent numerical values) can have any desired number format, for example binary values or integer numbers or floating-point numbers.

The input registers 10, 12 are configured to store or cache numerical values that are to be processed. Here, the first input register 10 stores a first input word (with partial words a₁, a₀) and the second input register 12 stores a second input word (with partial words b₁, b₀).

In the example shown, the input words are formed by two partial words with the same bit number. In general, the input words can be formed by more than two partial words and/or the partial words of an input word have different bit numbers.

The permutation unit 14 is connected to the first input register 10 and is configured, optionally in accordance with a permutation selection 24 or a permutation signal (permutation configuration signal), to swap (or not to swap) the partial words a₁, a₀ of the first input word. That is to say, the permutation unit 14 determines a permutation word 26 which is formed from the partial words of the first input word, wherein the order of the partial words in the first output word is optionally unchanged or changed compared with the order of the partial words in the first input word. In the example shown, with only two partial words, there are two selection possibilities or permutation possibilities: no swapping of the partial words or swapping of the partial words. In the case of more than two partial words, there may be more than two selection possibilities or permutation possibilities (for example, in the case of three partial words, up to six selection possibilities). The permutation signal or the permutation selection 24 thus results in a configuration of the permutation unit 14 corresponding to one of the respectively existing selection possibilities or permutation possibilities, i.e., corresponding to a permutation selection. The MAC circuit or its permutation unit 14 is configured such that there are at least two (mutually different) selection possibilities (permutation possibilities) or the permutation selection includes at least two selection possibilities (permutation possibilities).

The term “permutation” is used in the sense that the trivial case, i.e., no swapping takes place, can be included.

Accordingly, the case in which no swapping takes place can represent a permutation possibility. The permutation unit can be configured such that all mathematically possible permutations are realized or can be configured such that only a part of all mathematically possible permutations is realized (but, as mentioned, at least two permutation possibilities should be realized).

The multiplication unit 16 is connected to the permutation unit 14 and the second input register 12 and is configured to multiply the permutation word 26 determined by the permutation unit 14 by the second input word stored in the second input register 12 in order to determine a summand word 28. In this case, optionally in accordance with a multiplication selection, for example a signal which is designated as multiplication signal 30, the permutation word 26 and the second input word are multiplied together as a whole or on a partial word basis. Multiplication as a whole should mean that the permutation word and the second input word are each regarded as a whole as numerical values that are multiplied by one another. In this case, the summand word 28 is accordingly the product of these two numerical values. The term “multiplication” is intended to mean that mutually corresponding partial words of the permutation word and of the second input word are interpreted as (independent) numerical values and are multiplied together. In this case, the summand word 28 comprises a plurality of (in this case two) partial words (also referred to as product partial words) which correspond to the products of the corresponding partial words of the permutation word and of the second input word (or are these products). The summand word 28 can (for instance, if integer numbers are used), as shown, have a higher number of bits (here 2n) than the permutation word 26 or the second input word.

The case may also be provided in which the multiplication unit 16 always carries out a multiplication on a partial-word basis, i.e., is only configured to perform the multiplication of the permutation word by the second input word on a partial-word basis. The optional multiplication as a whole thus represents an optional embodiment. If this is not provided, the multiplication signal 30 or the multiplication selection can be omitted.

The accumulation unit 18 illustrated comprises an adder 32 and an accumulation register 34. The adder 32 is configured to add the summand word 28 determined by the multiplication unit 16 and an accumulation word stored in the accumulation register 34, which accumulation word includes two or generally a plurality of partial words acc₁, acc₀, and to store the resulting summand word as an updated accumulation word in the accumulation register 34. The summand word and the stored accumulation word can optionally be added, e.g., in accordance with an accumulation signal 31 or an accumulation selection, as a whole (the summand word and the accumulation word are interpreted as numerical values) or on a partial-word basis (product partial words or partial words of the summand word and partial words of the accumulation word are in each case interpreted as independent numerical values). In the latter case, mutually corresponding partial words of the summand word and of the stored accumulation word are added together (i.e., product partial words and partial words of the accumulation word which correspond to one another are added together), in order to determine the partial words aac₁, aac₀ of the updated accumulation word. As in the multiplication unit, the case may be provided in which the accumulation unit is configured such that an addition only on a partial-word basis takes place, i.e., that the addition as a whole and accordingly the configuration possibility with the accumulation signal is not provided. In addition, a reset signal can be provided with which the accumulation register 34, i.e., the accumulation word or its partial words, can be reset to a predetermined value, in particular zero.

The multiplication signal 30 and the accumulation signal 31 are regarded above as different control signals. However, it may also be the case that they coincide (e.g., as a processing signal) when there are clearly mutually corresponding selection possibilities in the multiplication unit and the accumulation unit.

Depending on whether or not the partial words of the first input word are swapped in the permutation unit 14, different operations are performed (for the same input words) or different accumulation values are determined.

If a swapping of the partial words takes place, there results (wherein by aac₁, aac₀ on the left in the equations, the updated partial word is to be understood and on the right the partial word before the update):

$${acc}_{1 , 0} = \{ \begin{matrix}{acc}_{1} = {acc}_{1} + {a}_{0} \cdot {b}_{1} \\ {acc}_{0} = {acc}_{0} + {a}_{1} \cdot {b}_{0}\end{matrix}$$

If the partial words are not swapped, the following results:

$${acc}_{1 , 0} = \{ \begin{matrix}{acc}_{1} = {acc}_{1} + {a}_{1} \cdot {b}_{1} \\ {acc}_{0} = {acc}_{0} + {a}_{0} \cdot {b}_{0}\end{matrix}$$

It can be seen that the partial words a₁, a₀ in the expressions have been swapped. In order to obtain these expressions, it is assumed that the multiplication unit 16 and the accumulation unit 18 or its adder 32 perform a multiplication or addition on a partial-word basis.

The bit shift unit 20 (or shift unit) is connected to the accumulation unit 18 or to its accumulation register 34 and is configured to receive the accumulation word acc₁, acc₀, i.e., to read the accumulation register 34, optionally corresponding to a shift signal 36 or a shift selection, and to store a specific section (e.g., the n lowest-value or highest-value bits) of the optionally shifted accumulation word in the result register 22. By means of the shift signal 36, the mode in which the shift is to take place and/or a number of bits by which the shift is to be effected can be specified. The mode can, for example, be a shift of the entire accumulation word by a number of bits which, for example, is specified in the shift signal, or a (parallel) shift of each of the partial words can be a number of bits which, for example, are specified in the shift signal (wherein partial words are not pushed into other partial words, i.e., for example, bits of a low-value partial word are not pushed into bits of a higher-value bit). The specification of by how many bits are shifted can also be made, for example, by the shift signal 36, via the selection from least one predefined (i.e., implemented in hardware) number of bits. Depending on the design, embodiments are of course also conceivable in which only a single mode is implemented and/or is always shifted by the same number of bits; in this case or in these cases a shift signal can be dispensed with, or the shift signal can only trigger the shift.

In other words, partial words of the accumulation word can be extracted and stored in the result register 22 as the corresponding result word. The result word itself can in turn also be regarded as being formed from partial words cy, Co. For example, by sequentially controlling the bit shift unit 20 in accordance with the mode mentioned above as the first mode, with the accumulation word unchanged, to shift the accumulation word by a different number of bits in each case (in the MAC circuit illustrated, for example, once by 0 bits and once by n bits), the partial words of the accumulation word can be stored sequentially in the result register 22 and read out from there. In the mode mentioned above as the second mode, the partial words can be read out simultaneously or in parallel.

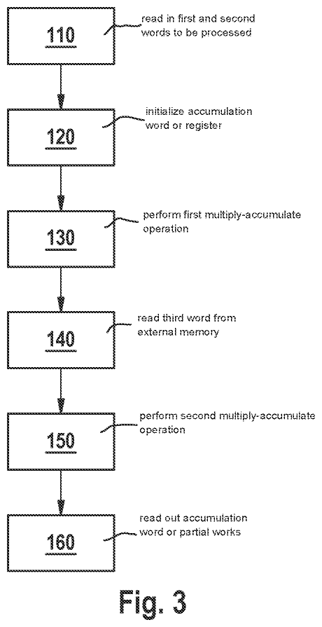

The multiply-accumulate circuit can be controlled, for example, by means of a control circuit (not shown). The control circuit is configured in particular to write input words (which are read from a memory by the control circuit, for example) into the first and the second input register 10, 12; to generate control signals for the multiply-accumulate circuit and to thereby control them; and to read out results from the result register 22 (and store them, for example, in a memory). The control signals are, for example, the permutation signal (corresponding to the permutation selection 24) for the permutation unit 14, the processing signal (corresponding to the processing selection 30) for the multiplication unit 16 and the accumulation unit 18 or its adder 32, and the shift signal (corresponding to the shift selection 36) for the bit shift unit 20. The control circuit can in particular be configured to carry out a method according to the present invention, as shown, for example, in FIG. 3.

In the MAC circuit of FIG. 1, the individual functionalities implemented by the MAC circuit (i.e., permutation of the partial words of the first input word, multiplication of the partial word, accumulation) are realized, for example, in each case in corresponding functional units (permutation unit, multiplication unit, accumulation unit).

In contrast, it is likewise possible for the functionalities or parts of the functionalities to be realized jointly or partially jointly in corresponding units, wherein even a different chronological sequence of functionalities or of parts of the functionalities can be implemented at least partially. For example, it could be provided that initially all possible products of partial words of the first input word with partial words of the second input word or at least all products of partial words of the first input word with partial words of the second input word that appear in the permutation possibilities implemented by the MAC circuit are determined and from these products the products that correspond to the permutation selection predetermined by the permutation signal are selected and added to the accumulation word. For this purpose, the MAC circuit could comprise corresponding execution units for the product formations. One or more intermediate registers could possibly be provided into which certain products are loaded in sequence in accordance with the permutation signal in order to be added to one partial word or in parallel to a plurality of partial words of the accumulation word. In this way, for example, different types of accumulation can be realized (wherein a selection of those to be used is made with the accumulation signal).

Furthermore, as regards all embodiments, a different weighting of the product partial words can also be provided, wherein before accumulation the product partial words are multiplied by a weight factor that can be different for different product partial words.

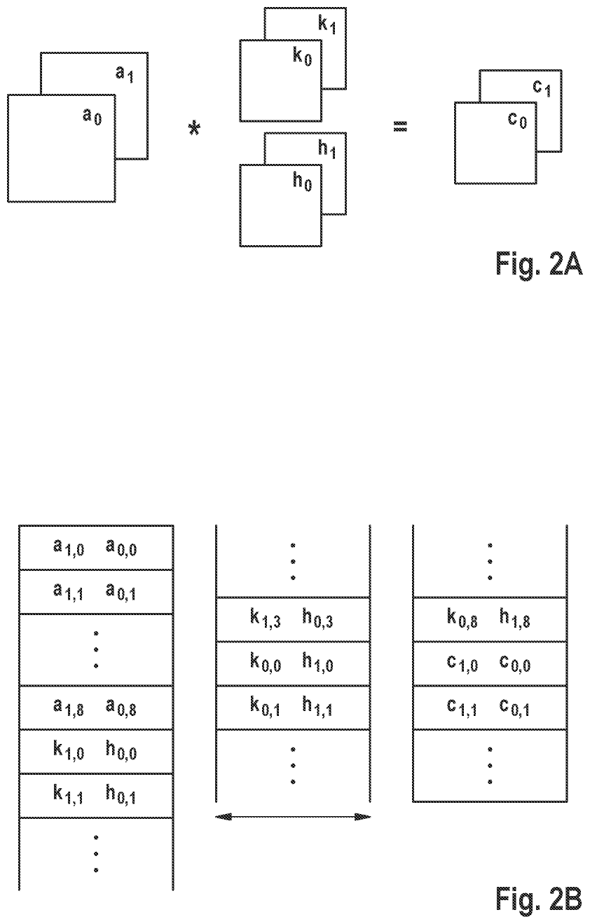

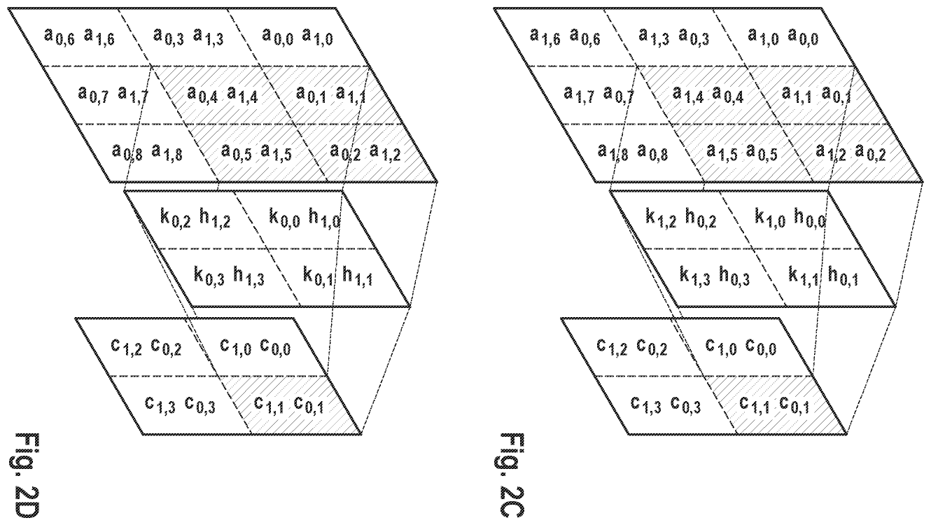

FIGS. 2A, 2B, 2C, 2D illustrate a convolution operation or convolution as an example of an operation that can be carried out efficiently using one or more MAC circuits (as shown in FIG. 1, for example).

FIG. 2A illustrates the convolution operation to be performed, in which the convolution of input matrices or input arrays a₀, a₁ with weight arrays h₀, h₁, k₀, k₁ is to be determined, in order to determine output arrays c₀, c₁ (it should be noted that a₀, a₁ and also c₀, c₁ in FIG. 2A, unlike a₁, a₀ and c₁, c₀ in FIG. 1, do not denote any partial words). For example, it should be the case that c₀=a₀*h₀+a₁*h₁ and c₁=a₀*k₀+a₁*k₁, where * stands for the convolution operation. For reasons of clarity, the input arrays, weight arrays and output arrays only have nine or four entries. In general, these arrays may have other dimensions, in particular be larger.

The input arrays a₀, a₁ have, for example, in each case nine entries: aᵢ={a_{i,j}}, wherein i=0, 1 and j=0, 1, . . . , 8. Mutually corresponding entries in the input arrays (i.e., with the same subscript j) can be understood as partial words of words. FIG. 2B, which represents a section of a memory, shows a corresponding storage of the words consisting of partial words. In FIG. 2C, the partial words combined into words (entries in the input arrays) are shown as a 3×3 matrix, as used in the convolution. In the 3×3 matrix in FIG. 2D, the partial words of the respective words are swapped round.

The weight arrays h₀, h₁, k₀, k₁ have, for example, in each case four entries: h₁={h_{i,j}} or kᵢ={k_{i,j}}, wherein i=0, 1 and j=0, 1, 2, 3. Here, mutually corresponding entries in the weight arrays h₀ and k₁ or weight arrays h₁ and k₀ can be understood as partial words of words. The storage of these words is shown in FIG. 2B. FIGS. 2C, 2D show corresponding 2×2 matrices, as used in the convolution.

The output arrays c₀, c₁ have, for example, in each case 4 entries: cᵢ={c_{i,j}}, wherein i=0, 1 and j=0, 1, 2, 3. Mutually corresponding entries in the output arrays can be understood as partial words of words. The storage of these words is again shown in FIG. 2B. FIGS. 2C, 2D show corresponding 2×2 matrices, as used in the convolution.

The entry c_{1,1} c_{0,1} is determined by the convolution as follows, wherein FIG. 2C (with no swapping, hereinafter additionally denoted by superscript U) and FIG. 2D (with swapping, hereinafter additionally denoted by superscript V) are distinguished (the superscripts U and V have been omitted in the figures for the sake of clarity).

With no swapping:

$${c}_{0 , 1}^{U} = {a}_{0 , 1} {h}_{0 , 0} + {a}_{0 , 2} {h}_{0 , 1} + {a}_{0 , 4} {h}_{0 , 2} + {a}_{0 , 5} {h}_{0 , 3}$$

$${c}_{1 , 1}^{U} = {a}_{1 , 1} {k}_{1 , 0} + {a}_{1 , 2} {k}_{1 , 1} + {a}_{1 , 4} {k}_{1 , 2} + {a}_{1 , 5} {k}_{1 , 3}$$

With swapping:

$${c}_{0 , 1}^{V} = {a}_{1 , 1} {h}_{1 , 0} + {a}_{1 , 2} {h}_{1 , 1} + {a}_{1 , 4} {h}_{1 , 2} + {a}_{1 , 5} {h}_{1 , 3}$$

$${c}_{1 , 1}^{V} = {a}_{0 , 1} {k}_{0 , 0} + {a}_{0 , 2} {k}_{0 , 1} + {a}_{0 , 4} {k}_{0 , 2} + {a}_{0 , 5} {k}_{0 , 3}$$

In order to determine, as desired, c₀=a₀*h₀+a₁*h₁ and c₁=a₀*k₀+a₁*k₁, it is therefore necessary to determine c_{0,1}^{U}+c_{0,1}^{V} and c_{1,1}^{U}+c_{1,1}^{V}. For this purpose, the proposed MAC circuit can expediently be used. First, the accumulation word or its partial words are reset to zero. Then, the word consisting of the partial words a_{1,0}, a_{0,0} is loaded as the first input word and the word consisting of the partial words k_{1,0}, h_{0,0} is loaded as the second input word and the multiplication and the addition to the accumulation value are performed on a partial-word basis (here the partial words of the first input word are not swapped).

Next, the partial words of the first input word are swapped (without reloading) and the word consisting of the partial words k_{0,0}, h_{1,0} is loaded as the second input word, and the multiplication and the addition to the accumulation value are performed on a partial-word basis. As a result, the first summands of the above expressions for c_{0,1}^{U}, c_{1,1}^{U}, c_{0,1}^{V}, c_{1,1}^{V} are determined as well as suitably added. This is repeated analogously for the further words of the input array and of the weight arrays in order to determine the further summands of the above expressions for c_{0,1}^{U}, c_{1,1}^{U}, c_{0,1}^{V}, c_{1,1}^{V} (without resetting in the meantime the accumulation word or its partial word to zero).

By permuting the partial words of the first input word, memory accesses can be avoided. Overall, the calculation can thus be accelerated and the energy consumption associated with memory accesses can be reduced. The more partial words the input words have, the greater this effect will be. Partial words can describe different properties of data to be processed, for example different color channels of a digital image.

FIG. 3 shows an exemplary flowchart of the method for performing multiply-accumulate operations, wherein one embodiment of a multiply-accumulate circuit according to the present invention, as shown, for example, in FIG. 1, is used.

In step 110, a first word to be processed and a second word to be processed are read from an external memory (i.e., a circuit-external memory). The words to be processed are each formed from partial words. In addition to the external memory, a local memory can be provided which, for example, is integrated with several MAC circuits on a chip and has a relatively short access time (in contrast to the external memory).

In an optional step 120, which can also be carried out before or at least partially simultaneously with step 110, the accumulation word or the accumulation register is initialized, i.e., the accumulation word or its partial words are reset to a predetermined value, which is in particular zero. In the further course of the method, the accumulation word is not reset.

In step 130 (which is optionally performed after step 120), the multiply-accumulate circuit is controlled to perform a first multiply-accumulate operation, wherein the first word to be processed is used as the first input word, the second word to be processed is used as the second input word, and a first permutation selection is made from the at least two permutation possibilities.

Next or at least after the multiplication on a partial-word basis has been carried out in step 120, a third word to be processed (which is formed from partial words) is read from the external memory in step 140.

In step 150, the multiply-accumulate circuit is controlled to perform a second multiply-accumulate operation, wherein the first word to be processed is used as the first input word (the first word to be processed can, for example, remain in the first input register or be downloaded from the local memory), the third word to be processed is used as the second input word, and a second permutation selection is made from the at least two permutation possibilities that differs from the first permutation selection. As already mentioned, the accumulation word is not reset prior to step 150, unlike as before step 130.

Steps 140 and 150 can be repeated for further words to be processed which are used in the relevant pass as the second input word, in particular if there are more than two permutation possibilities for the first input word, i.e., if this is formed from more than two partial words.

In step 160, the accumulation word or partial words of the accumulation word is read out in order to obtain the final result of the multiply-accumulate operations.

What is claimed is:

1. A multiply-accumulate circuit for processing numerical values that are present as input words, each of which is formed from at least two partial words, the circuit being configured to:
form product partial words as products of each partial word of the first input word of the input words with a different partial word of the second input word of the input words, wherein the partial words of the first input word are permutated relative to their original order corresponding to a permutation selected from a plurality of permulation possibilities implemented by the multiply-accumulate circuit; and
add the product partial words with an accumulation word, which is formed from one or more partial words, in order to determine an updated accumulation word in which product partial words are in each case added to one of the one or more partial words of the accumulation word.

2. The multiply-accumulate circuit according to claim 1, wherein the permutation selection is given by a permutation selection signal.

3. The multiply-accumulate circuit according to claim 1, wherein the multiply-accumulate circuit is configured to add each of the product partial words to a corresponding one of the partial words of the accumulation word, wherein a number of partial words of the accumulation word is equal to a number of product partial words.

4. The multiply-accumulate circuit according to claim 1, wherein:
the multiply-accumulate circuit is configured to add each of the product partial words to a corresponding one of the partial words of the accumulation word, wherein a number of partial words of the accumulation word is equal to a number of product partial words, or
to add a plurality of the product partial words to the same partial word of the accumulation word, wherein the accumulation word is formed from only one partial word.

5. The multiply-accumulate circuit according to claim 4, wherein the multiply-accumulate circuit is configured to add the product partial words with at least partially different weight factors to the corresponding partial word of the accumulation word.

6. The multiply-accumulate circuit according to claim 4, wherein the multiply-accumulate circuit is configured to add a plurality of the product partial words to the same partial word of the accumulation word, wherein the product partial words which are added to the same partial word of the accumulation word are added with at least partially different weight factors, wherein the accumulation word is formed from only one partial word.

7. The multiply-accumulate circuit according to claim 1, wherein the multiply-accumulate circuit is configured to form a summand word including the product partial words that are to be added with partial words of the accumulation word.

8. The multiply-accumulate circuit according to claim 2, wherein the multiply-accumulate circuit is configured to determine the product partial words in parallel for at least two of the plurality of implemented permutation possibilities, and, from the product partial words, to select in accordance with the permutation signal, the product partial words which correspond to one or more of the permutation possibilities and to use them in the addition with the accumulation word.

9. The multiply-accumulate circuit according to claim 8, comprising:
a permutation unit that implements the at least two permutation possibilities and is configured to determine from a first input word a permutation word that is formed from the partial words of the first input word, wherein an order of the partial words of the first input word is optionally permutated according to the permutation selection;
a multiplication unit which is configured to multiply partial words of the permutation word with partial words of the second input word in order to determine the product partial words, and to determine a summand word including the product partial words; and
an accumulation unit configured to add each of the product partial words included in the summand word to one of the one or more partial words of the accumulation word to determine the updated accumulation word.

10. The multiply-accumulate circuit according to claim 9, wherein:
the multiplication unit is configured to multiply the permutation word with the second input word as a whole in order to determine the summand word; and
the accumulation unit is configured to add the summand word with an accumulation word as a whole in order to determine the updated accumulation word.

11. The multiply-accumulate circuit according to claim 9, wherein the accumulation unit includes an adder configured to add the summand word and the accumulation word to determine the updated accumulation word.

12. The multiply-accumulate circuit according to claim 9, further comprising a first input register configured to store the first input word, and/or a second input register configured to store the second input word, and/or an accumulation register configured to store the accumulation word.

13. The multiply-accumulate circuit according to claim 9, further comprising a bit shift unit configured to, corresponding to a shift signal, shift the accumulation word as a whole by a number of bits that can be predetermined by the shift signal in order to determine partial words of the accumulation word, and/or to shift each of the partial words of the accumulation word by a number of bits that can be predetermined by the shift signal.

14. The multiply-accumulate circuit according to claim 13, further comprising a result register configured to receive from the bit shift unit and store partial words of the accumulation word or parts of the partial words of the accumulation word.

15. A method for performing multiply-accumulate operations using a multiply-accumulate circuit configured to process numerical values that are present as input words, each of which is formed from at least two partial words, the circuit being configured to:
form product partial words as products of each partial word of the first input word of the input words with a different partial word of the second input word of the input words, wherein the partial words of the first input word are permutated relative to their original order corresponding to a permutation selected from a plurality of permulation possibilities implemented by the multiply-accumulate circuit; and
add the product partial words with an accumulation word, which is formed from one or more partial words, in order to determine an updated accumulation word in which product partial words are in each case added to one of the one or more partial words of the accumulation word;
the method comprising the following steps:
reading a first word to be processed and a second word to be processed from an external memory;
controlling the multiply-accumulate circuit to perform a first multiply-accumulate operation, wherein the first word to be processed is used as the first input word, the second word to be processed is used as the second input word, and a first permutation selection is made from the plurality of permutation possibilities;
reading a third word to be processed from the external memory;
controlling the multiply-accumulate circuit to perform a second multiply-accumulate operation, wherein the first word to be processed is used as the first input word, the third word to be processed is used as the second input word, and a second permutation selection is made from the plurality of permutation possibilities that differs from the first permutation selection; and
reading out the accumulation word or partial words of the accumulation word.

16. The method according to claim 15, further comprising resetting the accumulation word to a predetermined value which is equal to zero, before the first multiply-accumulate operation.
